(19) United States
(12) Patent Application Publication
(10) Pub. No.: US 2011/0102352 A1
(43) Pub. Date: May 5, 2011

(54) GENERATING A MESSAGE TO BE TRANSMITTED

(75) Inventors: Pavankumar M. Dadlani Mahtani, Eindhoven (NL); Robert Van Herk, Eindhoven (NL)

(73) Assignee: KONINKLIJKE PHILIPS ELECTRONICS N.V., EINDHOVEN (NL)

(21) Appl. No.: 12/991,169

(22) PCT Filed: May 4, 2009
(86) PCT No.: PCT/IB09/51804

§ 371 Date: Dec. 30, 2010

(30) Foreign Application Priority Data
May 9, 2008 (EP) 08156007.0

(51) Int. Cl. G06F 3/041

(52) U.S. Cl. 345/173

(57) ABSTRACT

An apparatus for transmitting an emotion or action to a remote party is described, which is implemented as a photo-frame. Radio frequency identifier tags (200) each represent an emotion/action. When a tag is held near or placed on a photo, the respective action or emotion is identified based on the tags identifier and the destination is identified based on the location (112) of the tag on the photo-frame, which provides the network address to which the emotion/action should be transmitted.

### TECHNICAL FIELD

The present invention relates to an apparatus and a method for generating a message to be transmitted.

The present invention furthermore relates to an apparatus and method for displaying a received message.

### DESCRIPTION OF RELATED ART

Being able to share feelings or emotions with family members or friends living at a distance is difficult. Some people are shy to convey emotions directly to others and tend to use other means such as letters or electronic mediums.

Recently, some proposals have been made for systems that enable users to share an emotion or feeling with a remote person. One of these proposals is described in the article “Designing Emotional Awareness Devices: What One Sees Is What one Feels” by Andres Neyem et al, Ingeniare, Revista chilena de ingeniería, vol. 15 No 3, 2007. Herein, an apparatus is disclosed in the form of an every day picture frame. It is composed of two parts. The first part is a picture area, which shows a picture that represents an emotional state of a remote person. The second part is a feeling area, which comprises amongst others so called “emotional buttons”. When the user wants to transmit some feeling, he or she has to press the corresponding emotional button. The emotional buttons each have a different color that represents some emotional state, which is to be transmitted to a remote person. The transmission of the emotional state results in this state being displayed at the picture area of the apparatus of the remote person, for example by means of blinking light or colored light.

However, this apparatus has some limitations, the most important one being that the communication of the emotions is one-to-one, i.e. the communication is limited to two pre-defined persons.

It is an object of the invention to provide an apparatus enabling the communication of content, such as the emotional state of its user to different remote people. It is a further object of the invention to provide an apparatus for displaying the emotional state of different remote people.

### SUMMARY OF THE INVENTION

Thereto, according to an aspect of the invention an apparatus according to independent claims 1 and 10 and a method according to independent claims 11 and 12 are provided. Favorable embodiments are defined in dependent claims 2-9 and 13-15.

According to an aspect of the invention an apparatus is provided for generating a message to be transmitted. It comprises a detector for detecting one of a plurality of areas on a surface of the apparatus, that is touched by an input object, where the object is closest to or where the object is pointed to, and for detecting one of a plurality of inputs of a further type. It further comprises a generator for generating the message to be transmitted based on the detected area and the detected input of the further type. Thereto, the generator may comprise a retriever for retrieving a message destination and a message content corresponding to the detected area and the detected input of the further type. Thereto, the retriever may use a look-up table that maps the plurality of areas and the plurality of inputs of the further type to a plurality of destinations and a plurality of message contents. The message content may represent an emotional state of the user of the apparatus, such as joy or love or an action of care, such as a hug or a kiss. The destination corresponds to the remote person to which the message should be sent. The generator may further comprise a composer that composes the message to be transmitted, for example by composing a message having a message header that comprises the retrieved destination address and a payload that comprises the retrieved content. This message is transmitted by a transmitter that may be part of the apparatus or externally arranged. In this way an apparatus is provided that is able to generate a message, such as an emotion or an action, which is to be transmitted to any of a group of different persons, in a user friendly way. The group of persons consists for example of members of a family or a group of friends.

According to an embodiment of the invention, the message destination corresponds to the detected area on the surface of the apparatus and the message content corresponds to the detected input of the further type. In this way, the user is enabled to select the person to which the message is to be sent by positioning the input object on or near an area on the surface of the apparatus representing that person or by pointing the object to that area. The apparatus may be implemented as a photo-frame, having photos of family members and friends. The area of the photo is associated to the corresponding friend or family member. This enables the user to select the person whereto the message should be sent by positioning an object on or near the photo of this person or by pointing the object thereto.

According to an embodiment, the object that is used as input has an identifier and the input of the further type is an identifier of the object. This enables the user to select the content of the message by using the corresponding object.

The object that is used for inputting the message destination and the content thereof may be implemented as a tangible radio-frequency identification tag and the detector may comprise a radio frequency identification detection grid for detecting the area on the surface of the apparatus, whereto the object is nearest or whereto it is pointed and the identifier of the tag. The identifier of the tag corresponds to the content of the message to be transmitted, for example an emotion or action. In this case, the shape of the tag and/or a picture on the tag may represent the corresponding emotion or action. For example, a tag corresponding to the emotion “happiness” may have a picture on its surface of a smiling face and the tag corresponding to the emotional state “love” may have the shape of a heart. This enables the user to select the emotion or action to be transmitted in an intuitive way.

Alternatively, the object that is used for inputting the message destination and the content thereof is a body part of the user and the detector comprises a plurality of touch sensors for detecting the area on the surface of the apparatus, whereto the object is nearest or whereto it is pointed. In this way the user is enabled to select the destination of the message by touching the corresponding photo. The detector may comprise light sensors and/or cameras for detecting the way in which the user touches the photo by detecting the gesture or movement of the body part. This enables the user to select the emotion or action, for example by stroking or kissing the photo.

According to an alternative embodiment the message content corresponds to the detected area on the surface of the apparatus, whereto the object is nearest or whereto it is pointed and the message destination corresponds to the detected input of the further type. In this case, the apparatus may be implemented as a photo-frame, having pictures or photos representing emotional states or actions, such as a photo of lips for the action “kiss” and a photo of a heart for the emotional state “love”. The area of the photo is associated to the corresponding message content. This enables the user to select the content of the message by positioning an object on or near the photo representing this content or by pointing the object thereto. In case that the object that is used for inputting the message destination and the content thereof is implemented as a tangible radio-frequency identification tag, the tag identity may correspond to the destination of the message. In this case the tags may be small figurines each corresponding to a friend or family member, for example a figurine of an elderly man corresponds to grand father, a figurine of a small boy corresponds to “my baby brother”, etc. This enables the user to select the destination of the message by using the corresponding tag. Alternatively, tagged printed pictures of these persons may be used.

All these embodiments enable the user to select the destination of the message to be transmitted and the emotional state or action in an intuitive way.

According to a further aspect of the invention, at the receiving end an apparatus is provided for displaying the message. The apparatus comprises a determiner for determining the origin of the message and the content of the message. A retriever retrieves a display area and a display effect corresponding to the message origin and the message content. Thereto, the retriever may use a look-up table that maps a plurality of origins and a plurality of message contents to a plurality of areas and a plurality of effects. The display displays the retrieved effect at the retrieved area. The display effect may be the blinking or glowing of light or the display of certain pictures, color patterns, graphics or text at the retrieved location.

In this way an apparatus is provided that enables the user to recognize the message sender and the content, such as his/her emotional state, at a glance.

According to an embodiment of the invention, the display area corresponds to the origin of the message and the display effect to the message content. The apparatus may be implemented as a photo-frame, having photos of family members and friends, wherein the area of the photo is associated to the corresponding friend or family member. In this case, the display location corresponds to the photo of the sender and the display effect corresponds to his/her emotional state. For example, a heart may be displayed over photo of a sender to convey his/her emotional state “love” or the picture glows with a bright color to convey his/her emotional state “happiness”.

According to an alternative embodiment of the invention, the display area corresponds to the message content and the display effect to the origin of the message. In this case the apparatus may be implemented as a photo-frame, having pictures or photos representing emotional states or actions, such as a photo of lips for the action “kiss” and a photo of a heart for the emotional state “love”. In this case, the display area corresponds to the emotional state or action of the sender and the display effect corresponds to the sender of the message. For example, the name of the sender may be displayed over the photo of a heart to convey his/her emotional state “love”.

According to a still further aspect of the invention, a method is provided for generating a message to be transmitted comprising the following steps:

detecting one of a plurality of areas on a surface of the apparatus, that is touched by an object, where the object is closest to or where the object is pointed to, and for detecting one of a plurality of inputs of a further type, and

generating the message to be transmitted based on the detected area and the detected input of the further type.

According to a still further aspect of the invention a method is provided for displaying a received message comprising the steps of:

determining the origin of the message and the content of the message,

retrieving a display area and a display effect corresponding to the message origin and the message content, and

displaying the retrieved effect at the retrieved area.

Preferably, the methods according to the invention are, at least partially, implemented by means of a computer program.

These and other aspects of the invention will be apparent from and elucidated with reference to the embodiments described hereinafter.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 shows a functional block diagram of an apparatus according to an embodiment of the present invention.

FIG. 2 shows the apparatus depicted in FIG. 1 in case that radio-frequency identifier tags are used for selecting the destination and the content of the message to be transmitted.

FIG. 3 shows the apparatus depicted in FIG. 2 upon reception of a message.

FIG. 4 shows the apparatus depicted in FIG. 1 when body parts are used for selecting the destination and the content of the message to be transmitted.

FIG. 5 shows a flowchart illustrating the transmission of a message by the apparatus depicted in FIG. 1.

FIG. 6 shows a flowchart illustrating the reception of a message by the apparatus depicted in FIG. 1.

Throughout the figures like reference numerals refer to like elements.

### DETAILED DESCRIPTION OF THE PRESENT INVENTION

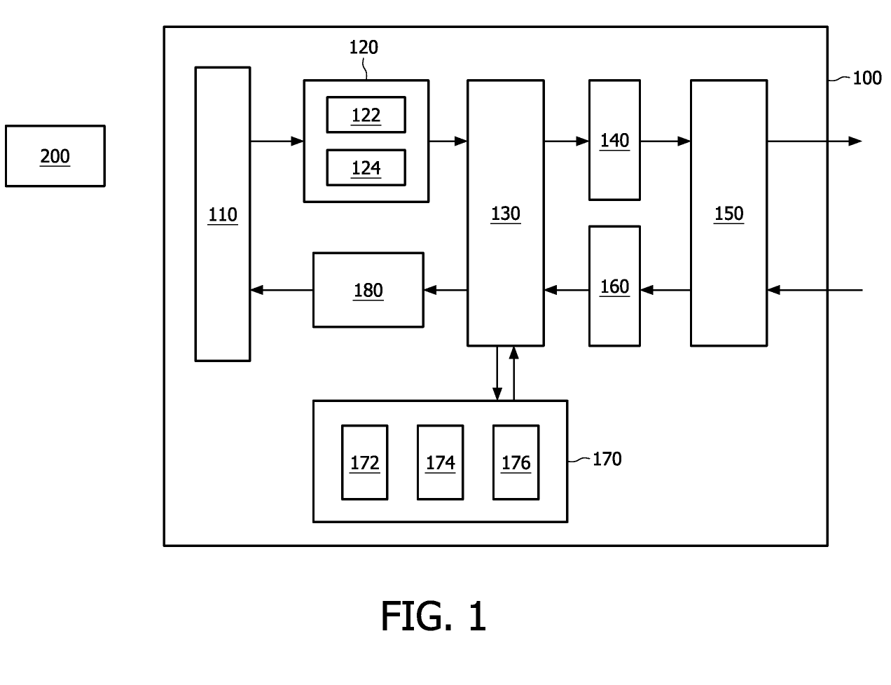

Referring to FIG. 1, an exemplary embodiment of the apparatus 100 according to the invention will be described. FIG. 1 shows a functional block diagram of the apparatus 100. It comprises a display 110, forming a surface of the apparatus. In the transmitting part of the apparatus a detector 120 is arranged, which has a first functional part 122 for detecting the area on the display 110 that is indicated by a user input object 200. Depending upon the implementation, the indicated area may be the area with which the object is in touch, where the object is closest to or where the object is pointed to. The detector 120 comprises a second functional part 124 for detecting which one of a plurality of inputs of a further type is selected by the user. It comprises a retriever 130 which, based upon the detected area on the display and the detected input of the further type retrieves a corresponding message destination and message content. Thereto the retriever consults a memory 170. The memory 170 comprises a first look-up table 172 mapping areas on the display 110 to network addresses of destinations, such as telephone numbers or E-mail addresses in a one-to-one fashion. The network address corresponds to the remote person to which the message should be sent. The memory 170 comprises a second look-up table 174 mapping inputs of the further type to predefined message contents in a one-to-one fashion. The message contents represent an emotional state of the user of the apparatus, such as joy or love or an action of care, such as a hug or a kiss. The message contents in the second look-up table 174 may be brief codes representing the emotions or actions, for example “001” represents “love”, “002” represents “happiness”, “003” represents “anger”, etc. A composer 140 composes the message to be transmitted by including the retrieved address in the header of the message and the content into the payload of the message. The retriever 130 and the composer 140 together are a message generator. A transceiver 150 sends the message to a remote destination, for example by means of SMS or E-mail.

In the receiving part of the apparatus the transceiver is adapted for receiving a message from third parties. A determiner 160 determines the origin and the content of the message. Based on the determined origin and the content of the message the retriever 130 retrieves the area on the display where the message should be displayed and the display effect. In order to retrieve the area on the display, the retriever consults the first look-up table 172, which comprises the one-to-one mapping of the network addresses to the areas on the display. In order to retrieve the display effect the retriever consults a third look-up table 176, which comprises a one-to-one mapping of message contents to display effects. The display effects may be the blinking or glowing of light or the display of certain pictures, graphics or text at the retrieved location. A display controller 180 controls the display 110 such that the received message is depicted by displaying the retrieved display effect at the retrieved location.

The retriever 130, generator 140 and determiner 160 may be implemented by means of a processor and its associated memory, loaded with a suitable computer program. The transceiver 150 may be an integral part of the apparatus 100 but it may also be arranged, externally to the apparatus 100, for example as an external SMS transceiver.

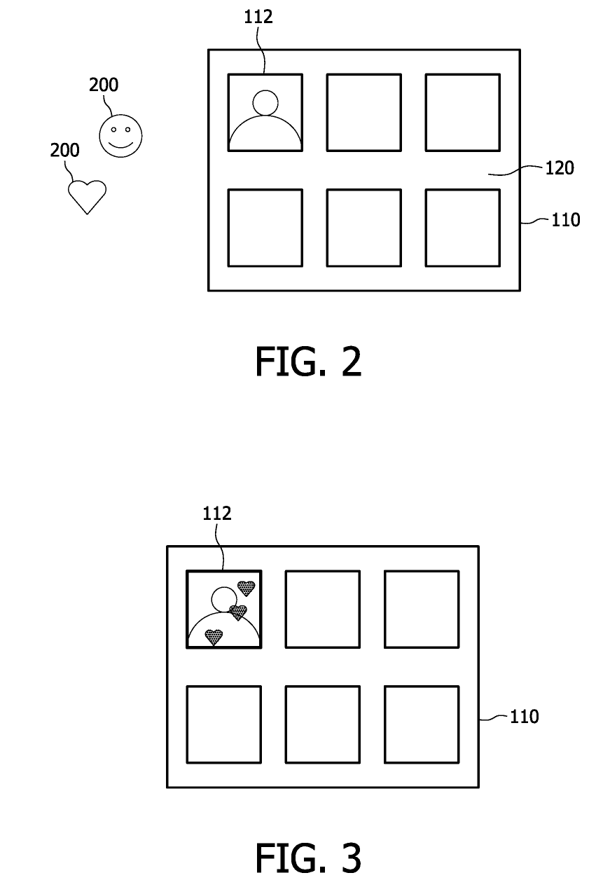

As shown in FIG. 2, the apparatus 100 may be implemented as a photo-frame. The display 110 depicts a plurality of pictures, each at a different display area 112 corresponding to a potential destination person of the message. The pictures at those areas each show this potential destination person. Tangible radio-frequency identifier (RFID) tags are used as input objects 200. By placing the apparatus 100 in the form of a photo frame in the home of each distant family member or friend of a certain group, those distant family members or friends can share emotions with each other or perform actions of care from their own homes using tangible objects and photos of their loved ones. In this case, the second look-up table 174 should comprise the mapping of the identifiers of the tags to corresponding predetermined emotions or actions. The shape of the tag and/or a picture on the tag describes the emotion or action it will convey to someone. For example, faces may be used to communicate emotions such as happy, sad, angry, etc., a heart nay be used to express love, lips to kiss, a hand to poke, arms to give a hug and so on. As shown in FIG. 2, a tag corresponding to the emotion “happiness” has a picture on its surface of a smiling face and the tag corresponding to the emotional state “love” has the shape of a heart. Each tag has a specific ID. The detector 120 is implemented by means of a RFID detection grid. It detects both the area on the display to which the tag is the closest and the identifier of the tag. As a result, when a particular tag is placed on or near a photo, the respective action or emotion is identified based on the tag's ID and the destination is identified based on the location of the tag on the grid, which provides a network address. The detector grid acts as a location map of different family members or friends: each area is associated with a specific family member or friend. This can be graphically represented by using photos. Each photo on the grid has a corresponding network address.

Upon reception of a message representing an emotion or action from a sender, the message is depicted by displaying the effect corresponding to the emotion or action at the area corresponding to the picture of the sender. FIG. 3 shows the display of the emotion “love” by displaying three hearts over the picture of the sender. Additionally, sound may be applied to represent the emotion or action or text for example: Mom sending love to you” or “John just kissed you”.

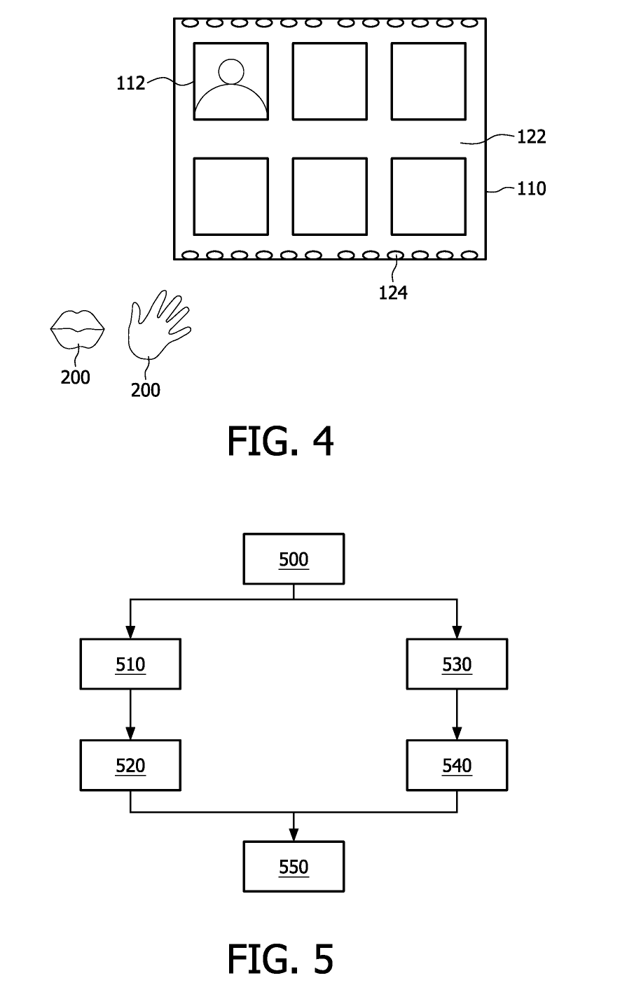

Instead of using a physical object, according to an alternative implementation shown in FIG. 4 a body part (e.g. face or hand) can be used to convey the emotion or action. In this case the first functional part of the detector 120 is implemented as of a touch sensor 122 and the second functional part of the detector 120 is implemented as an array of light sensors 124 or cameras with gesture recognition in order to detect the body part gesture and movement. Hereby, the respective emotion or action will be identified. The touch sensor 122 will identify the area that is touched by the body part, thereby enabling the generation of the network address to which the emotion or action should be sent. Based on the identified body part and its gesture, the corresponding emotion or action is identified and included as content in the message to be transmitted. So, emotions may be transmitted by for example poking on someone using the finger, stroking on someone using the hand or kissing on the picture. Alternatively or additionally, microphones may be provided for registering audio and an audio scene analysis may be performed where an additional look-up table is provided with sounds relevant to the body parts. The retriever looks for patterns of sounds as stored in the look up table and uses this table to identify the sounds (e.g. kiss sound or sound of blowing kiss).

FIG. 5 shows a flowchart with the steps that are needed for transmitting a message with the apparatuses as shown in FIGS. 2-4, which are the following:

Step 500: User holds a RFID tag near a photo of the picture frame (in the implementation according to FIGS. 2-3) or he/she touches the photo in a certain way (in the implementation according to FIG. 4).
Step 510: The detector reads out the ID code stored on the tag (in the implementation according to FIGS. 2-3) or detects the way of touching of the photo (in the implementation according to FIG. 4).
Step 520: The retriever looks up the emotion coupled to that code (in the implementation according to FIGS. 2-3) or coupled to that way of touching (in the implementation according to FIG. 4).
Step 530: The detector resolves the area of the display where the tag is closest to (in the implementation according to FIGS. 2-3) or which is touched (in the implementation according to FIG. 4).
Step 540: The retriever looks up the destination address coupled to that area.
Step 550: A message relevant to that emotion is composed and transmitted to that destination address.

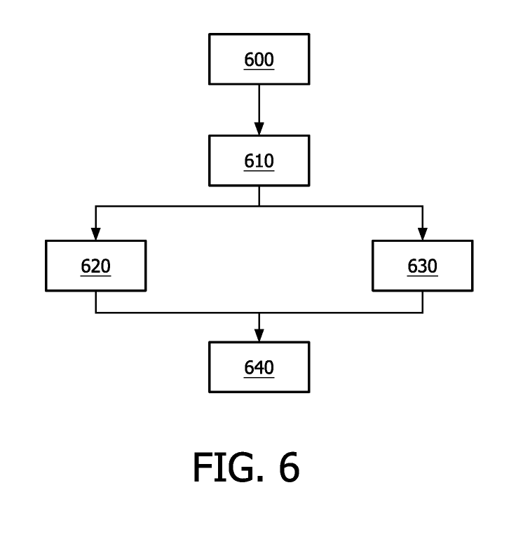

FIG. 6 shows a flowchart with the steps that are needed for receiving a message with the apparatus as shown in FIGS. 2-4, which are the following:

Step 600: The apparatus receives a message conveying an emotion from a sender.
Step 610: The determiner determines the address of the sender and the emotion according to the message.
Step 620: The retriever looks up the effect corresponding to that emotion.
Step 630: The retriever looks up the location corresponding to that sender.
Step 640: The display renders that effect on that location.

While the invention has been illustrated and described in detail in the drawings and foregoing description, such illustration and description are to be considered illustrative or exemplary and not restrictive; the invention is not limited to the disclosed embodiments.

For instance, it is possible that the identities of the RFID tags are exactly the same as the codes that are used for sending the emotions to which they correspond. In this case the second look-up table 174 is not needed, because the RFID codes may be directly included as the message content to be transmitted.

Furthermore, instead of using different objects having different IDs that each correspond to a different emotion or action to be transmitted, it is possible to use a single object with different IDs that may be selected by the user. A user then selects the emotion/action to be transmitted by selecting the corresponding ID of the object.

Furthermore, in the implementation shown in FIGS. 2-3 the tag identity may correspond to the destination of the message and the area on the display to the emotion or action that is to be transmitted. So, in this case different tags are used to transmit messages to different persons. The photo-frame may have pictures or photos representing emotional states or actions, such as a photo of lips for the action “kiss” and a photo of a heart for the emotional state “love”. The area of the photo is associated to the corresponding message content. This enables the user to select the content of the message to be transmitted to a certain person by positioning a tag representing this person near the photo representing the content. The tags may be small figurines each corresponding to a friend or family member, for example a figurine of an elderly man corresponds to grand father, a figurine of a small boy corresponds to “my baby brother”, etc. In this case the first look-up table 172 should map the areas on the display 110 to the message contents representing the corresponding emotions or actions and the second look-up table 174 should map the tag IDs to the network addresses of the corresponding destinations. It is also possible that the network addresses of the destinations are used as the IDs of the corresponding RFID tags. In this case, the second look-up table can be dispensed with.

Furthermore, instead of detecting the area of the photo-frame to which the object is closest or which is touched by the object, it is also possible to detect the area to which the object is pointed. Thereto, the objects may be provided with small and cheap directional antennas or if infrared technologies are used, the objects and/or the photo-frame may be provided with remote control pointing technology, as for example disclosed in the patent application WO-A-2007/105132 of the applicant.

In the present description, the following two examples are given of the input of a further type: the identifier of the RFID tag and the way of touching an area by a body part of the user. However, the input of the further type may be different, for example it may be the activation of a button corresponding to a certain emotion to be transmitted, as disclosed in the article “Designing Emotional Awareness Devices: What One Sees Is What one Feels” by Andres Neyem et al, referred to herein above.

Instead of transmitting the message by SMS or E-mail it is also possible to set-up a telephone connection to transmit the message. In this case, the retrieved network address is used by a dialer to set-up a connection and the content of the message may be transmitted e.g. by means of DTMF-tones.

In the present description the message content corresponds to emotions and/or actions of care. However, the principles of the present invention are of course also applicable to messages having any other content.

It is also possible that the apparatus according to the invention is only adapted for one-way communication, i.e. only for transmission or only for reception. In one scenario, only one household of a family has the photo frame to send the emotions or actions by SMS, and the other ones just use a mobile phone, which simply displays the received SMS message comprising the emotions or actions transmitted by the household with the photo frame. In an alternative scenario, some households have a photo frame for two-way communication and some other ones have a photo frame only for receiving, because they do not feel the need to transmit their emotions to other parties but still like to receive emotions transmitted by other parties.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. Apparatus (100) for generating a message to be transmitted comprising:
a detector (120) for detecting one of a plurality of areas (112) on a surface of the apparatus, that is touched by an object (200), where the object is closest to or where the object is pointed to, and for detecting one of a plurality of inputs of a further type, and
a generator (130,140) for generating the message to be transmitted based on the detected area and the detected input of the further type.

2. Apparatus according to claim 1 wherein the message destination corresponds to the detected area and the message content corresponds to the detected input of the further type.

3. Apparatus according to claim 1 wherein the object has an identifier and wherein the input of the further type is an identifier of the object.

4. Apparatus according to claim 3 wherein the object is a tangible radio-frequency identification tag and the detector comprises a radio frequency identification detection grid for detecting the area and the identifier.

5. Apparatus according to claim 1 wherein the detector comprises:
a plurality of touch sensors (122) for detecting the area; or
at least a light sensor and/or camera and/or microphone for detecting a gesture, movement or sound of the object.

6. Apparatus according to claim 1 wherein the message destination corresponds to the detected input of the further type and the message content corresponds to the detected area.

7. Apparatus (100) for displaying a received message comprising:
a determiner (160) for determining the sender of the message and the content of the message,
a retriever (130) for retrieving a display area (112) and a display effect corresponding to the message sender and the message content, and
a display (110) for displaying the retrieved effect at the retrieved area.

8. Method for generating a message to be transmitted comprising the following steps:
detecting (410) one of a plurality of areas on a surface of the apparatus, that is touched by an object, where the object is closest to or where the object is pointed to, and detecting (430) one of a plurality of inputs of a further type, and
generating (420,440,450) the message to be transmitted based on the detected area and the detected input of the further type.

9. Method for displaying a received message comprising the steps of:
determining the sender of the message and the content of the message,
retrieving a display area and a display effect corresponding to the message sender and the message content, and
displaying the retrieved effect at the retrieved area.

10. A computer program comprising computer program code means adapted to perform the steps of claim 8, when said program is run on a computer.
